(19) United States
(12) Patent Application Publication
(10) Pub. No.: US 2018/0351758 A1
(43) Pub. Date: Dec. 6, 2018

(54) Home Automation System

(71) Applicant: Gernot Becker, Dortmund (DE)

(72) Inventor: Gernot Becker, Dortmund (DE)

(73) Assignee: innogy SE, Essen (DE)

(21) Appl. No.: 16/059,291

(22) Filed: Aug. 9, 2018

Related U.S. Application Data
(63) Continuation of application No. PCT/EP2016/075761, filed on Oct. 26, 2016.

(30) Foreign Application Priority Data
Nov. 2, 2016 (DE) 10 2016 102 402.3

(51) Int. Cl. H04L 12/28; G06T 7/73

(52) U.S. Cl. CPC H04L 12/282; G06T 2207/30196; G06T 7/74; H04L 12/2827

(57) ABSTRACT

Provided herein are embodiments of a home automation system. The home automation system includes display means configured to display a view of at least one part of a floor plan of a spatial environment of the home automation system. An intuitive and simplified set-up takes place by the programming means being configured to program at least one action of an actuator of the home automation system based on the currently displayed view of the floor plan and a function of the actuator and/or a sensor of the home automation system.

### CROSS-REFERENCE TO RELATED PATENT APPLICATIONS

This patent application is a continuation of PCT Application No. PCT/EP2016/075761, filed Oct. 26, 2016, which claims priority to German Application No. 10 2016 102 402.3, filed Feb. 11, 2016, the entire teachings and disclosure of which are incorporated herein by reference thereto.

### FIELD

The subject matter relates to a home automation system and a method for operating a home automation system.

### BACKGROUND

Home automation solutions are becoming increasingly interesting for private users. The components used in home automation have been known for a long time such that comfortable operating concepts come in the focus to when developing home automation solutions. It is in particular becoming increasingly more important to precisely and reliably detect the position or presence of a user in the home controlled by the home automation system. Exact position detection allows new operating concepts to be implemented. New, intuitive operation, for example based on the position of a user is in particular possible based on exact position detection. Exact position detection also allows actuators and sensors to be virtually placed and also virtually programmed in an environment based on the floor plan of the environment determined by the position detection.

Presence detection is conventionally carried out by means of passive infrared sensors. However, these infrared sensors only respond to movements such that the user cannot be definitively detected when they do not move much. Other methods, such as for example ultrasonic sensors or microwave sensors have not caught on in the mass market because they require a plurality of sensors, they are technically complex and are thus complicated to install. In addition, these sensors can detect only a change in the room structure which can also originate from a change of position of objects.

### BRIEF SUMMARY

The object is to improve the position detection of users in home automation systems using existing technologies and based on the position detection to simplify the installation and use of the home automation system.

If sensors or actuators are mentioned below, what is always meant is that both a sensor and an actuator can be meant alternatively or cumulatively.

It has been recognised that based on exact positioning, a floor plan of a house, a building, an office, a factory building or the like can also be automatically detected. The inventors have also recognised that, based on a displayed floor plan, programming of the home automation system is essentially more intuitive. A user is preferably guided through the floor plan in a virtual environment or can navigate or move in the floor plan automatically using a screen, virtual reality glasses or augmented reality glasses. The user can then carry out the programming they want within the floor plan at suitable points. The spatial association of their programming instructions to a sensor and/or actuator is directly possible since the current position is known in the floor plan and thus also the sensors and/or actuators located there.

Not only is the programming simplified, but it is also possible to output status information of sensors and/or actuators using the position of the user. It can in particular be determined by determining the position of the user in the floor plan which sensors or actuators are in a viewing range of this user. The current status can be retrieved from the sensors or actuators which are in the viewing range of the user, depending on their detected position. The sensor or actuator together with their status can then be displayed to the user at a correct position in the floor plan.

To this end, the home automation system firstly comprises display means configured to display a view of at least one part of a floor plan of a spatial environment of the home automation system. In the simplest case, the display means can be formed by a display or screen. The display means can, however, also be, for example, virtual reality glasses or also augmented reality glasses. The display means can display a section of the floor plan. This means that, in addition to the entire floor plan, the display means can also display only one part thereof. In particular if the display means are one of the mentioned glasses, the floor plan could also be a 3D view. It is not only outlines of the floor plan, i.e. for example, walls, doors, passageways etc., that can preferably be displayed on the display means, but also installations such as, for example, radiators, lamps, windows, doors, etc. Sensors and actuators are also displayed in the floor plan, their position being either automatic by position detection of the respective sensor or actuator or by manual positioning by the user. A sensor or actuator is thus displayed in the floor plan at its “actual” position. Depending on a current position of the user in the floor plan or their viewing direction, the display can also take place only with the sensors or actuators which are in the range of vision of the user.

In addition to the display means, programming means are also provided. The programming means are configured to program at least one action of an actuator of the home automation system based on the currently displayed view of the floor plan and a function of the actuator and/or a sensor of the home automation system. Using the programming means, relationships between actuators and sensors can be programmed. Functions of actuators and/or sensors can also be associated with one another using the programming means.

In the case of programming, a position in the floor plan can be associated with an actuator and/or a sensor based on the currently displayed view. With the aid of the programming means, it is possible to place actuators and/or sensors in the floor plan. The user can associate a position with a sensor and/or an actuator depending on their view.

With the aid of the programming means, programming can carry out at least one action of an actuator of the home automation system. The programming is, in this case, based on the currently displayed view of the floor plan and a function of the actuator or of a sensor of the home automation system. Depending on what the current view of the floor plan is, the “visible” sensors and/or actuators can for example be displayed in the floor plan. Furthermore, the functions and/or parameters of these actuators and/or sensors represented in the current view can then be accessed using the programming means. With the aid of these functions and/or parameters, the sensors and/or actuators can then be programmed. In particular, associations between represented actuators/sensors and sensors and/or actuators that are and/or are not represented can be programmed. Spatial associations between the floor plan and sensors or actuators to be programmed can also be carried out.

The programming means can also be configured to define virtual movement vectors and/or virtual trigger points in the currently displayed view in the floor plan and to associate at least one action of an actuator with them. Movement vectors can be defined by the user in the floor plan. Movement vectors can also contain corridors or multitudes of vectors. Starting regions and end regions can also be defined. If a user then moves along a vector, along a corridor and/or from a starting region into an end region, which can be detected by the position detection, an associated action can then be triggered by this movement. A trigger point can be a spatially defined region. If a user enters this region, which can also be detected by the position detection, an associated action can also be triggered. This action can be programmed in the floor plan.

With the aid of the current view, it is particularly comfortable to set the mentioned movement vectors, corridors and/or trigger points. The user can preferably graphically “draw in” the respective information in this view with an input device. Furthermore, functions, actions, parameters and/or the like of sensors or actuators are preferably displayed to the user which they can link to the defined movement vectors, corridors and/or trigger points.

The detection means are preferably configured to detect the floor plan, in particular the detection means are configured to detect a 3D floor plan. The detection means can for example continuously evaluate position information from users and create the floor plan from the evaluated position information. Regions, from which no position information is received, can in particular be labelled as “dead” regions. “Dead” regions are for example walls, cable ducts, etc. It is also possible to measure the floor plan for example by means of a domestic robot e.g. by means of a vacuum robot. In this case, position information can for example be detected by the robot and used to create the floor plan. An electronic floor plan created with the aid of a CAD program can be loaded into the detection means by means of a suitable interface. Any available architect plans can in particular be electronically input via the detection means and made available for further use in the representational system.

Augmented reality is a further embodiment. It is hereby possible to supplement real, displayed objects with further objects inserted into the display. For example, the floor plan together with an actually currently recorded image of the environment can be represented on a display. In addition, information on sensors or actuators arranged in the viewing field can be inserted into the display. The display means are thus preferably configured to display a view of the floor plan together with a display of a real image.

In order to design the display as comprehensibly as possible, it is advantageous for sensors or actuators to be discernible as such directly in the display. This is particularly the case when the sensors or actuators are visually represented. Icons representing sensors or actuators, for example pictograms can in particular be provided which are represented in the display. If, for example, a real, recorded image is displayed, the viewing direction of this image can be detected. It can then be determined which sensors or actuators are available in this field of vision. These can then be superimposed with the icons associated with them and represented in the display.

It is also proposed that the display means are configured to display the icons depending on a status of an actuators and/or sensor. It is hereby for example possible to only display icons when the sensors and/or actuators are active. It may, for example, also be possible if a sensor is programmed in a current view to only display the actuators which can interact with the sensor to be programmed.

It is also proposed that the programming means are configured to receive status values from simulated environmental variables, the environmental variables having a programmed influence on a status of an actuator and/or sensor and the display means being configured to display a status of the actuator and/or sensor based on the simulated environmental variables. With the aid of the simulated environmental variables, it is possible to test programming. It is thus for example possible to simulate twilight values, wind strength values, temperature values, status of other sensors, e.g. of window contacts, buttons or switches, thermostats or the like as environmental variables. As soon as the environmental variables are simulated, actions are carried out or triggered by further sensors or actuators, which were associated with these environmental variables. A corresponding status change is preferably not carried out, but rather displayed only in the display. A user can thus check whether the actions programmed by him/her are also correct. The check can be made in the display by a display of the status of the displayed actuators or sensors.

It is also proposed that the display means comprises a mobile display device and that the display means represents a part of the floor plan depending on its detected position in the floor plan. Mobile display devices can, for example, be displays of smartphones or tablet computers. Laptops can also act as mobile display devices. Virtual reality glasses or augmented reality glasses can also serve as display devices. Their position in the floor plan can be determined. If the position is known, the floor plan can be superimposed into the display as it is represented from the current position.

It is also proposed that the detection means are configured to detect a user gesture, that the programming means evaluate the detected user gesture depending on the display of the floor plan and program at least one actuator and/or sensor depending on the user gesture and the currently displayed view of the floor plan. A sensor and an actuator can for example be displayed in the display. A user can for example perform a hand movement as a user gesture. This hand movement can for example be from the sensor to the actuator. If such a gesture is detected, programming can for example be carried out such that the sensor is associated with actuator. Options can subsequently for example be superimposed regarding how the actuator can respond to a different status of the sensor. The user can then program the responses of the actuator to a status of the sensor e.g. by a hand movement.

It has been known that with the aid of evaluation device, information from transmitters can be evaluated such that position information can be derived from the information of the transmitters. Transmitters in the sense of this application can be hand transmitters which are self-powered. Such transmitters can for example be near field transmitters, for example NFC transmitters, RFID transmitters, WLAN transmitters, Bluetooth transmitters or the like. Such transmitters are nowadays already installed in smartwatches and in smartphones. The transmitters have a transmitter device by means of which the transmitters can send at least one transmitter identification. The transmitters send a transmitter identification so that it can be determined at each receiver from which transmitter a signal originates.

In general, modern home automation systems are based on a radio protocol, in the case of which sensors and actuators communicate wirelessly with one another. Sensors and actuators of a home automation system are both sensors in the sense of the subject matter. Actuators also sense signals on the air interfaces and are thus sensors for transmitter identification.

The wireless communication of a home automation system generally takes place in the same frequency band in which the transmitters send their transmitter identification. It has now been recognised that with the aid of sensors of the home automation system already present, the transmitter identifications of the different types of transmitter can be received. The fixedly installed sensors and actuators of a home automation system in particular listen to the air interface for signals for the home automation system. Control notifications of the home automation system are in particular transmitted via the air interface. When listening to the air interface, these sensors and actuators can also serve as sensors for detecting and/or evaluating signals from transmitters, as they were described above.

A receive signal of a transmitter is received by each sensor. This receive signal of a transmitter is in particular the signal by means of which the transmitter sent its transmitter identification. Upon receipt of this signal, its receive field strength can be determined. To this end, suitable receiving chips are known. The receiving chips provide information on the receive field strength in addition to the receiving transmitter identification. Together with the information on which sensor received this signal, a receive signal can be detected. Each sensor can have a clear identification so that it can always be understood which sensors has received which receive signal.

The sensors each transmit the receive information composed of at least the receive field strength, the transmitter identification and the sensor identification to an evaluation device.

The evaluation device can evaluate the receive information from a plurality of sensors. In the case of the evaluation, the different receive information which originates from a transmitter and is received from a plurality of sensors in the same transmit interval in which the transmitter sent its identification, can be understood as a fingerprint of the transmitter. Since each individual receive field strength may be different in each sensor and the receive field strength is dependent in particular upon the distance of the transmitter from the respective sensor, information typical for the position of the transmitter can be determined as the fingerprint from the receive information of different sensors. Such a fingerprint can also be designated as the current signature. Such a fingerprint can also be designated as a position-variable signature.

It is thus possible to determine the position of this transmitter by way of evaluating different receive information which can be received by different sensors and associated with an individual transmitter and depending on this to derive actions or rules in the home automation system.

When sensors are mentioned in this document, these are not only classic sensors in the sense of a home automation system, but rather they always include all types of devices which can be incorporated into the home automation system, in particular those which are understood in the classic sense as sensors and actuators of a home automation system, for example buttons, switches, temperature sensors, brightness sensors, opening sensors, alarms, actuator motors or the like.

In order to evaluate the position of a transmitter, it may be reasonable for the receive information to be sorted according to transmitter identifications. In this respect, it is proposed that the evaluation device detects the respective receive field strengths and sensor identifications as the current signature for each transmitter from the receive information of at least two sensors. This detection of the current signature is preferably carried out in the evaluation device. Each transmitter sends its transmitter identification, which is received by different sensors. This receive signal has a characteristic receive field strength. Together with the information from which sensor the receive information originates, a current signature can be detected. The current signature can be a set made up of sensor identification and receive field strength of more than one sensor. With the aid of this signature, which represents a typical fingerprint for the position of the transmitter, position detection of the transmitter is possible within the home automation system.

In order to be able to associate the position of the transmitter with a local region within the home automation system, a training process is required. The system firstly knows only the signature but cannot yet assign it to any location. For this reason, it is proposed that in a training process at least one current signature is associated as the position signature with a local region, in particular a room and to store this association. The evaluation device can implement this association. The user can in particular move during the training with the transmitter and specify at determined times such that their position should be detected. The user assigns the detected current signature to a room by indicating their current actual position for example on a mobile end device, a tablet, a smartphone or the like, with which room they would like to associate the current signature. This association is stored as the position signature.

For exact positioning, it is relevant for a data set that is as large as possible to be used for the position signature, this means as many reference points as possible are known. In this respect, it is proposed that a set of receive field strength and respective sensor identification of at least two sensors, preferably more than two sensors in particular a plurality of sensors is stored as the position signature. A position signature can thus include the receive field strengths from different sensors and can be stored in a data set.

A room or local region does not have to include only a single position, but rather can also have a certain distribution. In order to satisfy this circumstance, it is reasonable for a plurality of current signatures to be associated with the same local region as the position signatures. This means that a matrix made up of a plurality of position signatures can be stored for a local region. For exact position detection, it is then possible to compare the current signature with the position signatures of the matrices and depending on a determined rule, which is described below, to deduce in which room or which local region the transmitter is located.

According to one embodiment, it is proposed for the position detection of a transmitter that the evaluation device detects a current signature from the receive information for a transmitter and compares the current signature with at least two position signatures. Following the training process, at least one position signature, preferably a set of a plurality of position signatures is stored for at least one spatial region, preferably for at least two or more spatial regions. If a current signature is now received, it can be compared with the stored position signatures. The position signature can then in particular be sought which has the smallest deviation from the current signature, in particular in the case of which the field strengths of the individual sensors of the current signature, in total or on average, deviate the least from the field strengths of one of the position signatures. If this position signature has been determined, the local region associated with this position signature can be determined and specified such that the transmitter is located in this local region.

If a plurality of position signatures is stored for a local region, it may be reasonable to determine an average differential value, preferably an arithmetic average of the differential values of the current signature from all position signatures which are associated with a local region. This average value is then compared with the average values of the deviation of the position signatures of the other local regions and the value with the smallest deviation determines the local region which is associated with the transmitter.

According to one embodiment, it is proposed that the evaluation device, for a comparison, firstly selects from the receive information that receive information which is associated with a transmitter.

It is conceivable for different transmitters to be active simultaneously in the home automation system and to send their transmitter identifications. In order to carry out a separate position determination for each transmitter, it is reasonable to firstly select from the receive information that receive information which originates from one and the same transmitter. To this end, it can firstly be checked in the evaluation device which transmitter identification has receive information and the receive information with the same transmitter identification can be used for a current signature.

As already mentioned, the current signature of a respective transmitter can be compared with position signatures. In this case, the values for the field strength of the receiving field of the transmitter identification are compared and a sum of the differential values for each comparison can be created. The differential value that is the lower belongs to the position signature which is associated with the local region in which the transmitter is located.

According to exemplary embodiment, it is proposed that the smallest differential value between current signature and at least two sets of position signatures is determined. The transmitter is associated with the local region in the case of whose set of position signatures the smallest differential value was determined.

During operation, additional position signatures can be provided. This is for example possible by current signatures always being converted to position signatures for a determined local region when the position of the transmitter is known. This may for example be the case if a user carries a transmitter with them and operates a switch of the home automation system. At this moment it is known in which room the switch is located. At the time of operation, the current signature of the transmitter is detected and associated as the position signature with the room in which the switch is located. The accuracy of the position detection can be improved by an iterative adaption or expansion of the position signatures for the respective local regions.

According to one embodiment, it is proposed that the evaluation device is formed as part of a sensor or as a device separated from a sensor inside the home automation system. The evaluation device can thus be made available as a separate part or separate device of the home automation system or can be an integral component. The evaluation device can in particular be arranged in a sensor or actuator of the home automation system.

The evaluation of the signatures can be carried out by using a neuronal network. This is already inventive on its own and can be combined with all features described here. The neuronal network learns the input positions indicated by the user and is trained further during use of the system and in particular by corrections applied by the user. The neuronal network becomes increasingly more reliable and better with time. A Kohonen network could in particular be used. It can represent the positions of the user as a stimulus and the output values as the trigger.

According to one embodiment, it is proposed that the sensors are fixedly incorporated in the home automation system and/or that the transmitter is a mobile, preferably self-powered transmitter. Different types of sensors and actuators are fixedly incorporated in the home automation system. These can be used as sensors for the objective position determination.

A self-powered supplied transmitter may be understood such that it is supplied for example from a battery. As mentioned, the sensors and the transmitter send on the same carrier frequency, in particular at 868 MHz.

According to one embodiment, it is proposed that the evaluation device creates a control telegram for an actuator of the home automation system depending the local region associated with the transmitter based on the current signature. This aspect is already inventive on its own. It is hereby possible for control telegrams to be created according to determined rules depending on the position detection. Position detection can, also independently of what has been described above, be established in the home automation system. As soon as a position of the transmitter is known, a rule can be associated with a position and depending on this rule, the control telegram can be created for a current home automation system.

According to one embodiment, it is proposed that a transmitter sends its transmitter identification in specified intervals. This means that the transmitter does not always send transmitter identifications, but only does this at certain times. This prevents the transmitter, in particular when it is self-powered supplied, consuming its electrically supplied energy too quickly. This increases the service life of the transmitter.

According to one embodiment, it is proposed that the evaluation device detects the intervals. As soon as it is known in the evaluation device at which intervals the transmitter sends its transmitter identification and if the time between transmitter and home automation system is synchronised, it is possible to activate the sensors to receive receive information as a function of the intervals. This means that the sensors then only listen to the air interface when it is expected that the transmitter sends a receive signal. The evaluation device can instruct the sensors accordingly and inform them concerning the intervals.

It is also possible for the receive intervals or receiving times of the sensors of the home automation systems to be known and for the evaluation device to make this information available to the transmitter. In this case, the transmitter can then send, depending on the receiving capacity of the home automation system, its transmitter identification at the times at which the sensors listen to the air interface anyway.

According to one embodiment, it is proposed that the evaluation device activates a selection of sensors depending on a preceding determination of the local region of a transmitter. It has been recognised that all sensors of the home automation system do not always have to receive the transmitter identification. In fact, if the position of the transmitter was detected once, it must be assumed that it moves linearly in the room and thus only has to be listened to in adjoining regions to the current position by the sensors arranged there. In this case, energy is saved in the case of the sensors which are far removed from the current position of the transmitter since they do not have to listen in this case. This linear change can also be interpreted again by the neuronal network which can in turn interpolate the prediction for the previously-known, learned user behaviour and derive programmed actions therefrom.

The movement profile of the transmitter can also comprise a gradient, which means that its speed is evaluated in the room as a positional change per unit of time. Depending on this gradient, a selection of the sensors can take place which are activated in order to receive the transmitter identification. The quicker a transmitter is moved, the larger the region can be which is covered by the current local region in which the sensors are activated.

A further aspect that is also inventive on its own may consist of a transmitter having at least one operating element, at least one function being associated with the operating element inside the home automation system and the associated function being dependent on the determination of the local region of a transmitter.

Independently of the above described position detection, it is possible for a transmitter, for example a hand transmitter, a smartphone, a tablet or the like to send its transmitter identification in the home automation system and/or be incorporated in the home automation system. An operating element may for example be present in this transmitter, which is intended for a determined function inside a room. This may for example be an on-switch of the ceiling light. A generic function may thus be associated with consistently the same operating element. If the position of the transmitter is known, the generic function may be carried out depending on the position in which a function valid for the current position is derived from the generic function.

In one example, this may mean that the generic function “ceiling lights”, if the recognised position is in a first room, is converted into the function “switch on the ceiling light in the first room”. If the position is detected in a second room, the generic function is converted into the function “switch on the ceiling light in the second room”.

In this connection, it should be mentioned that the transmitter with the operating element does not have to necessarily coincide with the transmitter which sends the transmitter identification. In fact, the transmitters can also come apart and be structurally separate units.

According to one embodiment, it is proposed that the transmitter has at least one operating element, that at least one function is associated with the operating element inside the home automation system and that the associated function is performed on the actuator which is associated with the determined local region of a sensor. The transmitters can also come apart here.

The previously-mentioned methods can also be implemented as a computer program or as a computer program stored on a storage medium. In this case, a microprocessor may be suitably programmed by a computer program to perform the respective method steps.

The features of the methods and devices are freely combinable with one another. Features and partial features of the description and/or dependent and independent claims, even fully or partially deviating from features or partial features of the independent claims, may be inventive on their own, alone or freely combined with one another.

### BRIEF DESCRIPTION OF THE DRAWINGS

The subject matter will be explained in detail below based on a drawing showing exemplary embodiments:

FIG. 1 a schematic view of a system with sensors and an evaluation device;

FIG. 2 a schematic view of a system with a transmitter and a plurality of sensors;

FIG. 3 a schematic view of receive information;

FIG. 4 a schematic view of a matrix with position signatures;

FIG. 5 a schematic view of a comparison of a current signature with position signatures;

FIG. 6 a schematic view of a hand transmitter and the use of said hand transmitter in a home automation system;

FIG. 7 a schematic view of transmit and receive intervals;

FIG. 8 a schematic view of a floor plan;

FIG. 9 a schematic view of a floor plan together with displayed sensors and actuators;

FIG. 10 a schematic view of a graphic association between sensors and actuators;

FIG. 11a a schematic view of a movement vector in a floor plan;

FIG. 11b a schematic view of a movement corridor in a floor plan;

FIG. 11c a schematic view of a trigger point in a floor plan;

### DETAILED DESCRIPTION

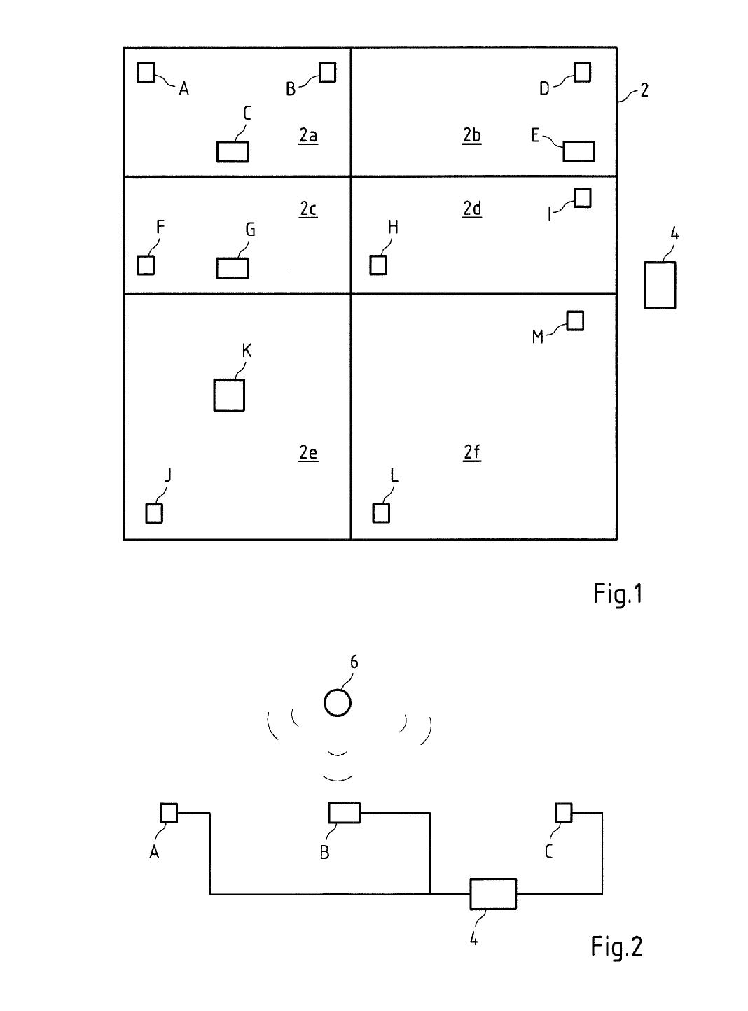

FIG. 1 shows a region 2 in which a home automation system is established. The region 2 is divided into six spatial regions 3a-f. The spatial regions 2a-f can for example be different rooms in a building or also determined regions within a room. At least one of the sensors A-M of the home automation system is installed in each of the spatial regions 2a-f.

In the example shown in FIG. 1, the sensors A, B and C are for example installed in the region 2a, the sensors D and E are installed in the region 2b, the sensors F and G are installed in the region 2c, the sensors H and I are installed in the region 2d, the sensors J and K are installed in the region 2e and the sensors L and M are installed in the region 2f.

In addition to the sensors A-M, an evaluation device 4 is provided which is in wireless or wired communication with the sensors A-M.

The sensors A-M can be the most varied of sensors or actuators of a home automation system. Conceivable sensors A to M in the sense of the subject matter are for example room thermostats, movement sensors, fire detectors, buttons, switches, switch actuators, dimmer actuators, binary inputs, shutter control, ventilation control, air-conditioning control, cameras or the like. The sensors A-M have in common that they can communicate with one another in a common frequency band and are thus part of the home automation system. The evaluation device 4 may also be part of the home automation system which can also be integrated in one of the sensors A to M.

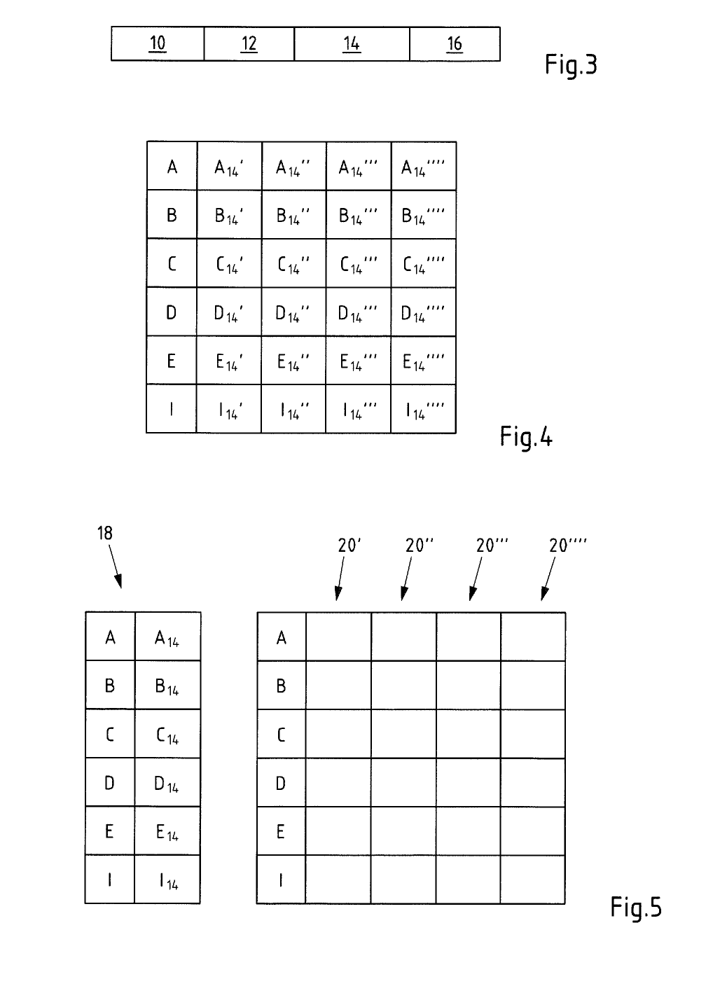

A transmitter 6, for example a telephone, a clock, a radio chip or the like can be used in the region 2 and moved freely in the region 2. The transmitter 6 sends on the same frequency as the sensors A-M, which is represented in FIG. 2. The transmitter 6 sends its transmitter identification in intervals which is for example a unique character sequence. Each of the sensors A-M in FIG. 2, only the sensors A-C are shown, can essentially receive this transmitter identification when the field strength of the transmitter identification is large enough at the sensor. The sensors A-C are connected in a wireless or wired manner to the evaluation device 4. Depending on the distance and other spatial relationship between the transmitter 6 and the sensors A-M, the field strength of the signal received by the transmitter 6 in one of the sensors A-C can vary. The sensors A-C evaluate not only the received transmitter identification, but also the field strength. The transmitter information received by the sensors A-C is converted into receive situations, as is represented as a data set in FIG. 3.

In FIG. 3, receive information 8 is represented as a data set. A transmitter identification 10 of the transmitter 6, a sensor identification 12 of one of the sensors A-M and information concerning the receive field strength 14 of the signal with which the transmitter identification was received and further test data or the like 16 is contained in the receive information 8.

The transmitter identification 10 may be a unique character sequence which clearly identifies each transmitter 6.

The sensor identification 12 may be a unique character sequence which clearly identifies each sensor A-M.

The receive field strength 14 can be information concerning how large the electric field of the signal was by means of which the transmitter identification was received in the sensor A-C. This may for example be value information. These three data items 10, 12, 14 together with the test data 16, for example CRC test data, can be transmitted by the sensors A-M to the evaluation device 4.

As is represented in FIG. 3, each sensors A-M, which receives the transmitter identification 10, creates receive information 8 at each time at which a transmitter 6 sends its transmitter identification 10.

The information 12 on the sensors A-M and the receive field strength 14 is extracted in the evaluation device 4 for each individual transmitter 6 using the transmitter identification 10. The information 12 of at least two sensors A-M with respect to the receive field strength may be understood as the current signature.

In a training process, at least one current signature, preferably a plurality of current signatures is associated with a spatial region 2a-f such that a matrix made of position signatures can be formed, as is represented in FIG. 4.

FIG. 4 shows for example a position signature, which is assigned to the spatial region 2b. It can be discerned that a set of receive field strengths A14′, B14′, C14′, D14′, E14′ and I14′ are stored by the sensors A, B, C, D, E and I. This information is associated with the spatial region 2b. This means that the matrix, as is represented in FIG. 4, which is composed of different current signatures, is associated with the spatial region 2b such that the signatures are position signatures. The information 14 on the receive field strengths, which are stored in the matrix according to FIG. 4, may also represent different positions of the transmitter 6 inside the spatial region 2b, which was detected in the training process.

At least one position signature, which corresponds to at least one column of the matrix according to FIG. 4, but preferably a plurality of position signatures in a matrix according to FIG. 4, is preferably detected in the training process for each spatial region 2a-f.

During operation, the position detection is carried out such that a current signature 18, as indicated in FIG. 5, is detected, in which the information 12 on the respective sensors A-I and the corresponding information 14 (A14 to I14) on the receive field strengths is included.

In the case of detecting the current signature, a quantity limitation may be present such that for example only the sensors A-M or their receive information is taken into account, in which the receive field strengths A14-I14 are the largest, i.e. the sensors A-M with the largest receive field strengths of the signal of the transmitter identification 10.

The current signature is subsequently compared with the individual position signatures 20′, 20″, 20′″, 20″″ in the matrix according to FIG. 4, the value of the receive field strength being compared for each individual sensor and a total of the differential values being determined. A total of the differential values between the respective stored receive field strengths and the receive field strengths of the current signature 18 being calculated for each position signature 20′. An average value for the total of the differential values can be calculated over all position signatures 20′-20″″. This is carried out for all matrices, which means for each of the rooms 2a-f there is a matrix according to FIG. 4 and the comparison according to FIG. 5 is carried out for each room.

It is subsequently determined which differential value is the smallest and the current signature 18 is associated with the room to which the corresponding matrix with the smallest differential value is also associated. In the present example, this could for example be the spatial region 2b.

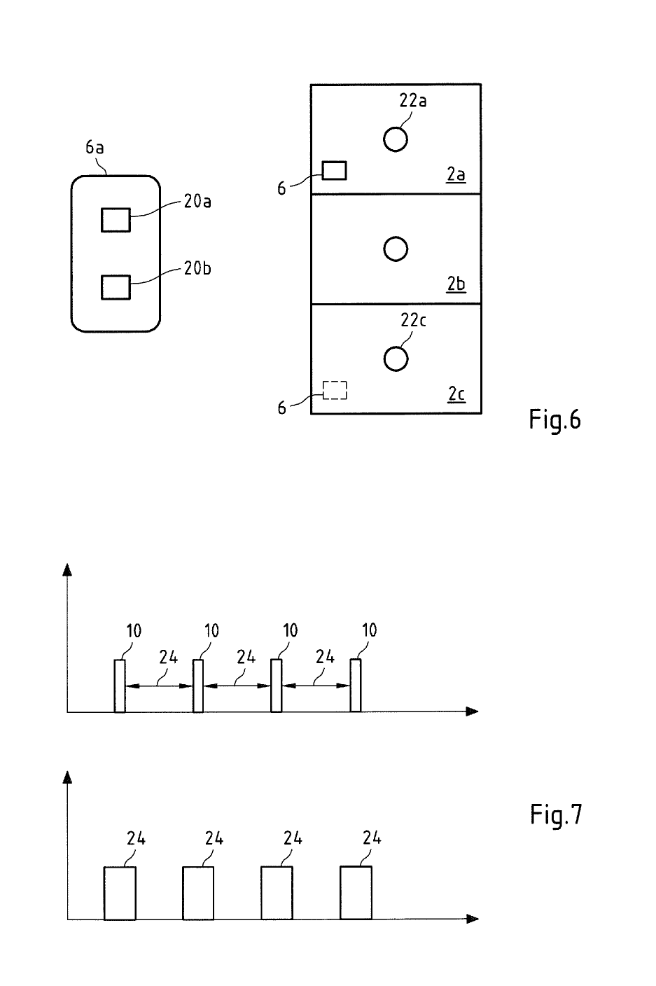

FIG. 6 shows an exemplary application of the position detection. A transmitter 6 can be present consecutively in different spatial regions 2a, b, c. This transmitter 6 can for example be a mobile hand transmitter 6a or a separate component from this mobile hand transmitter. Operating elements 20a, 20b are provided on the hand transmitter 6a. It is for example possible with the operating elements 20a, 20b to actuate determined functions of the home automation system. The operating element 20a can for example be programmed such that a ceiling light, if present, of a spatial region 2a-c is always activated. The mobile transmitter 6a is now moved into the spatial regions 2a-f and it is firstly for example detected that the mobile transmitter 6a is in the spatial region 2a. If at this moment the operating element 20a is pressed, then the ceiling light 22a is for example switched on or off depending on the detected position in the spatial region 2a.

If the transmitter 6a is, however, moved into the room 2c and if it is detected and if the operating element 20a is actuated, then the light 22a will no longer be switched, but rather the light 22c.

Therefore, a generic function is associated with one and the same operating element 20a which is, however, associated with a determined action or determined actuator depending on the detected spatial region.

FIG. 7 shows the time course of the sending of a transmitter identification 10 in intervals 24 by the transmitter 6. The interval duration of the intervals 24 can be detected by the evaluation device 4 and in accordance with the interval duration, activation of the sensors A-M can take place such that they listen at determined times, these times matching the transmit times of the transmitter identification 10.

On the other hand, it is also possible for the times at which the sensors A-M listen, to be known and depending on this the transmitter 6 is instructed by the evaluation device 4 to set the interval width 24 accordingly in order to accordingly only send the transmitter identification 10 when the sensors A-M are listening anyway. Both lead to a reduction of the power consumption either in the transmitter 6 or in the sensors A-M.

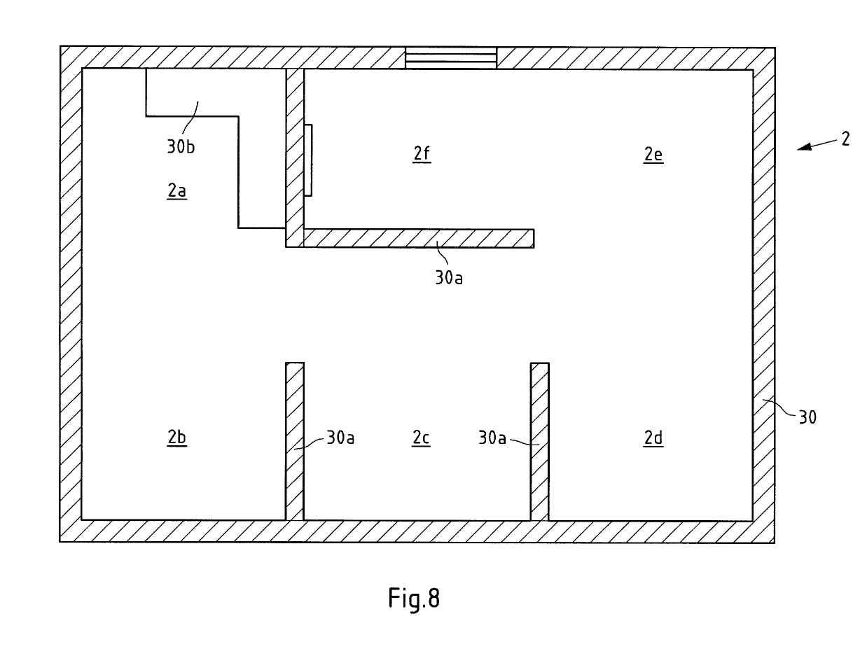

FIG. 8 shows the floor plan 30 of the region 2. The region 2 is broken down into the partial regions 2a-f. Walls 30a and fixed installations 30b can be discerned in the floor plan 30.

A transmitter 6 can, while it is moved in the floor plan 30, continuously be monitored. A transmitter 6 can for example be mounted on a domestic robot, e.g. a vacuum robot. It is determined from the position signatures received by the transmitter 6 where walls 30a and installations 30b are located in the floor plan 30. A position signature is not received in these regions such that these regions can be considered as a “dead” regions of the floor plan.

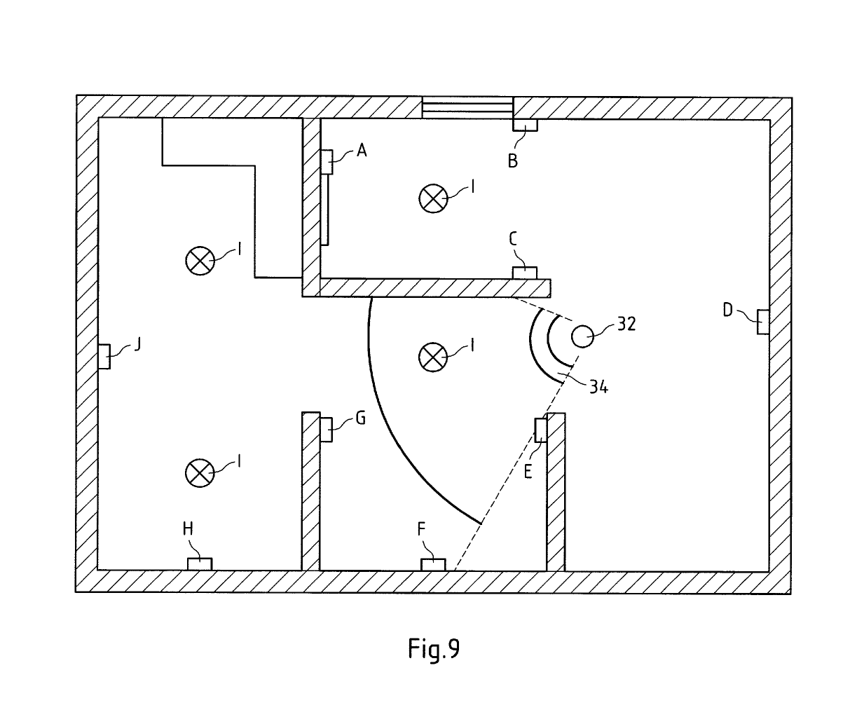

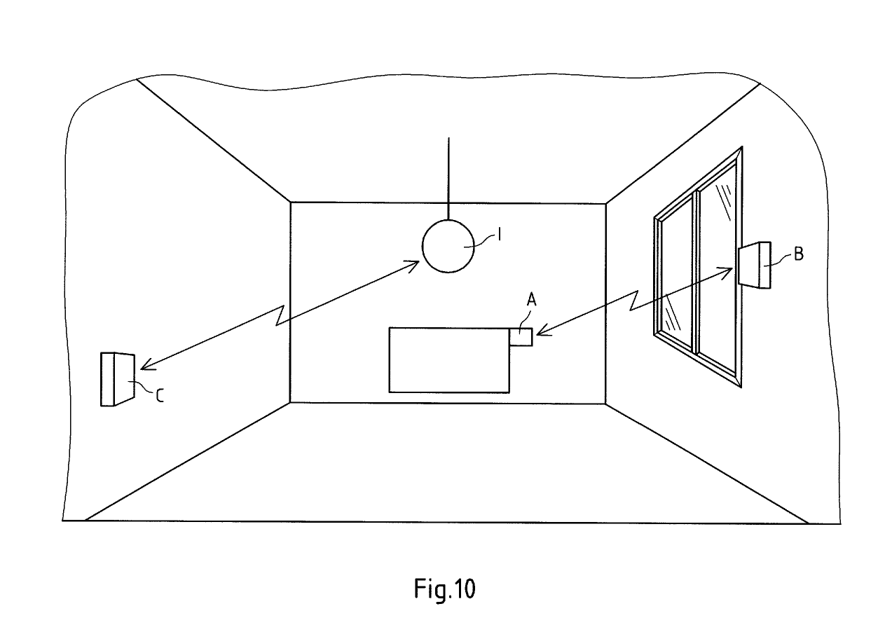

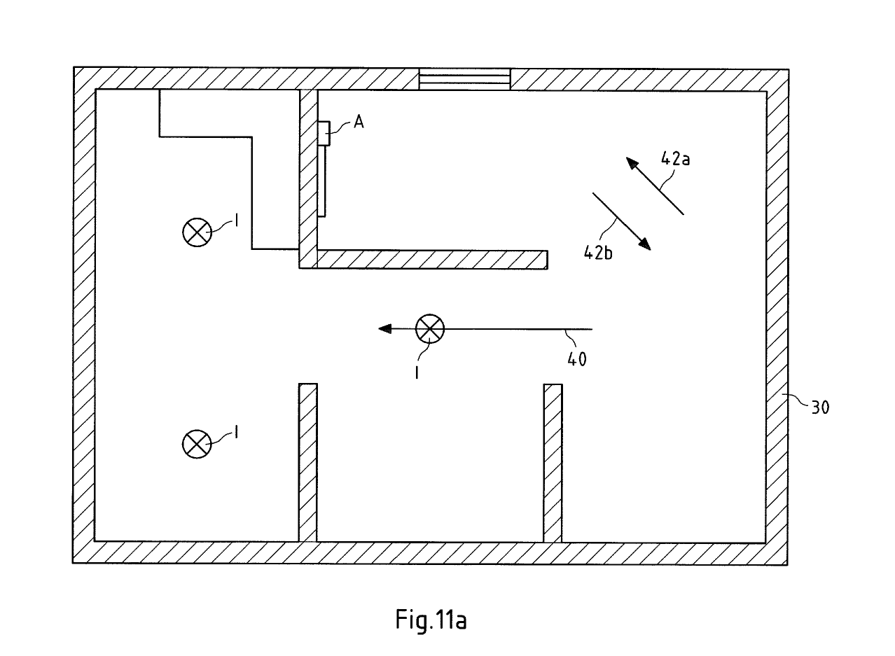

The initially detected floor plan 30 can be used to position actuators and sensors therein. This can be discerned in FIG. 9. The positioning of the sensors or actuators A-I can take place manually whereby the user places the sensors or actuators A-I in the current view of the floor plan 30. It is also possible to detect the position signatures of the respective sensors or actuators A-J and to determine their absolute or even relative position to one another in the floor plan 30.

The sensors or actuators A-J in FIG. 9 are for example as follows. The sensor A is a thermostat which is connected to a heating element and thus also to an actuator with an actuating drive for the heating element. The sensor B is for example a window opening sensors. The sensor C is a button. The sensor D is a movement sensor. The sensors E and G are switches. The sensors F, H, and J are a thermostat like the sensor A. The lamps I are indicated representatively for switch actuators.

If the user moves through the floor plan 30 which is represented for example by the user 32, their position can be determined. The user 32 also often has a display with them which they can align in a determined viewing direction designated here as 34. When the viewing direction 34 has been determined, the region of the floor plan 30 can be represented, which is discernible in this viewing direction. An augmented reality application can, in particular be supported in this case. The display device of the user detects an image in the viewing direction 34. This image is initially represented on the display.

Such a representation of an image in a determined viewing direction 34 is represented in FIG. 10. The display shows the recorded image.

In addition to the recorded image, a part of the floor plan 30 can be represented in the display. It is thus for example possible to superimpose the walls 30a in the representation of the recording for example as an overlay over the real image.

In addition to the representation of the part of the floor plan 30, it can be determined which sensors or actuators A-J are in the region of the viewing field. In the example represented in FIG. 9, these are the sensors/actuators E, F, G, I, J. These sensors/actuators E, F, G, I, J are represented by for example pictograms in the display. It is also possible to superimpose the status parameter or other information, such as for example the name of the sensor/actuator E, F, G, I, J.

A connection between the sensors/actuators E, F, G, I, J can subsequently be shown to the user. The user can for example set them via a menu. The arrangement of the sensors/actuators E, F, G, I, J in FIG. 10 does not correspond to that in FIG. 9 which is, however, irrelevant for understanding. The sensors/actuators A, B, C and I are also superimposed in the representation in FIG. 10 in the recorded image, which is represented. The user can display the association of the sensors to the actuators by selection in a menu. This is represented in FIG. 10 by connection lines between the sensors and actuators. It can be discerned here that in the example there is a connection between the window contact B and the thermostat A. If the user types out of this connection, they can for example display the programme rule associated with this association. In the example, this can for example be a reduction of the target temperature by 3 degrees in the case of opening the window.

An association between the button C and the actuator I can also be discerned. The rule can be programmed for this association such that the actuator I remains switched on for 10 minutes when the button C is pressed.

The display of the status of the sensors/actuators E, F, G, I, J is not represented in FIG. 10. But the user can also activate such a display via a menu.

With the aid of the camera, which is present on the display means, user gestures can also be detected. In the example represented in FIG. 10, the user could for example make a hand movement from the sensor C to the thermostat A. This hand movement could be detected by the camera. In this case, an association between a sensor and an actuator could firstly be saved, in the present case for example the button C and the thermostat A. A menu could subsequently be shown to the user in which the user receives the programme rules possible for such an association displayed. In the present case, this could for example be an increase in the target temperature by X degrees Celsius for Y minutes.

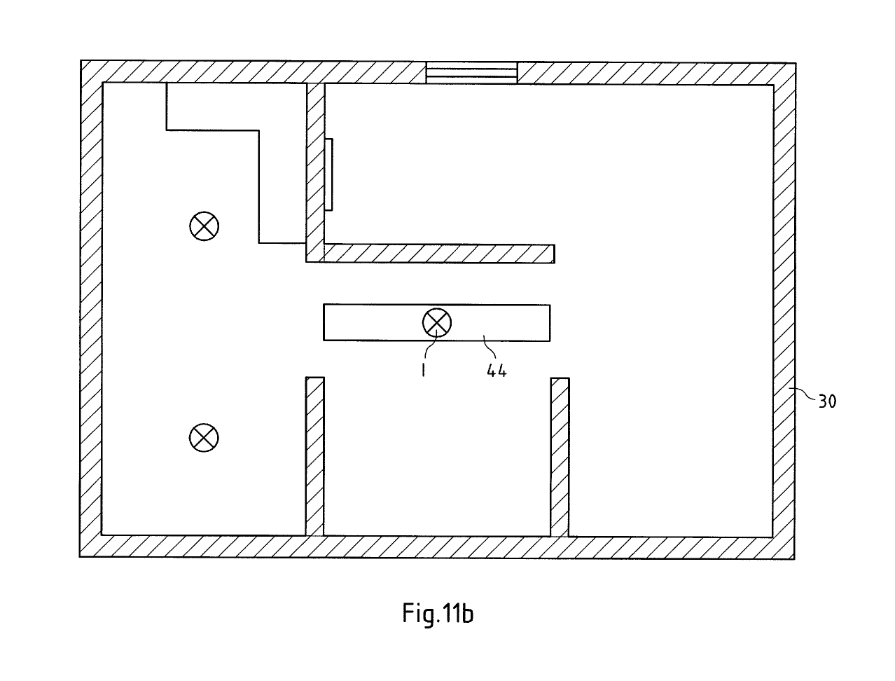

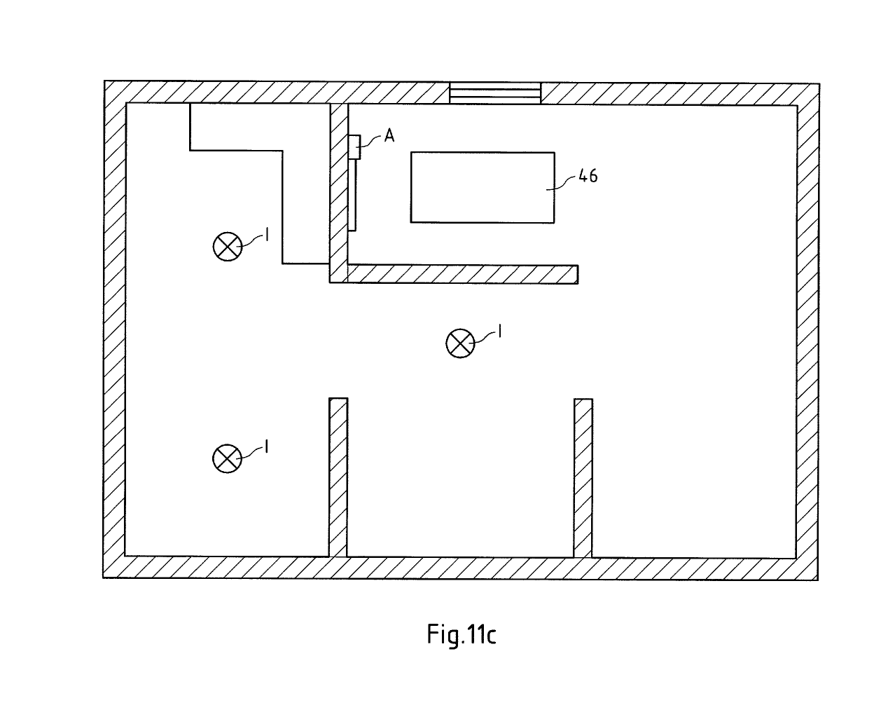

In addition to the association and programming of the sensors/actuators E, F, G, I, J, it is possible to trigger position-based actions. To this end, the user can define in the view of the floor plan, as is shown for example in FIG. 11a, movement vectors 40, 42a, 42b. This can be drawn in for example with an input device into the floor plan 30.

The user can subsequently assign actions to the movement vectors 40, 42s, 42b. The action “activate the actuators I” can for example be assigned to the movement vector 40.

If it is now determined during the position detection of a transmitter 6 that it is moved along the vector 40, the action assigned to this vector 40 takes place automatically and the lights I are switched on.

The same can be programmed for the vectors 42a, 42b. For the vector 42a, the target temperature of the thermostat A can be for example programmed to increase by 1 degree Celsius and for the vector 42b the target temperature can be for example programmed to reduce by 1 degree Celsius. The room temperature can be hereby increased when entering the room, which is detected by the movement of the transmitter 6 along the vector 42a and when leaving the room correspondingly decreased by movement along the vector 42b.

A movement corridor 44 is shown in FIG. 11b. Such a corridor 44 can also be programmed in the floor plan 30 by the user.

If the user moves along this corridor 44, the programmed action “activate the actuator I” is carried out.

A further example is shown in FIG. 11c. A trigger point 46 is drawn in there as a surface, just as the user can define/draw in this trigger point in the floor plan 33. The action can for example be associated with this trigger point 44 to increase the target temperature of the thermostat A by 1 degree Celsius. In addition, a further action can be associated with the trigger point 44. This can be for example the action “switch off the actuators I”. Therefore, if the transmitter 6 is detected in the region of the trigger point 46, a plurality of programmed actions can be triggered.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A home automation system, comprising:
at least one evaluation device;
a mobile display configured to display a view of at least one part of a floor plan of a spatial environment of the home automation system; and
a processor configured to program at least one action of an actuator of the home automation system based on the currently displayed view of the floor plan and a function of the actuator and/or a sensor of the home automation system;
wherein the evaluation device obtains from receive signals of a transmitter received by at least two sensors a respective receive filed strength together with a transmitter identification and a sensor identification as receive information and determines a position from the receive information, such that the mobile display shows a part of the floor plan depending on the detected position within the floor plan.

2. The home automation system according to claim 1, wherein the processor is configured to associate a position in the floor plan with an actuator and/or a sensor based on the currently displayed view.

3. The home automation system according to claim 1, wherein the processor is configured to define virtual movement vectors and/or virtual trigger points in the currently displayed view in the floor plan and to associate at least one action of an actuator with them.

4. The home automation system according to claim 1, wherein a detector is configured to detect the floor plan, in particular in that the detector is configured to detect a 3D floor plan.

5. The home automation system according to claim 1, wherein the mobile display is configured to display a view of the floor plan together with a display of a real image.

6. The home automation system according to claim 1, wherein the mobile display is configured to display icons representing actuators and/or sensors together with a real image.

7. The home automation system according to claim 6, wherein the mobile display is configured to display the icons depending on a status of an actuator and/or sensor.

8. The home automation system according to claim 1, wherein-the processor is configured to receive status values of simulated environmental variables, the environmental variables having a programmed influence on a status of an actuator and/or sensor and in that the display is configured to display a status of the actuator and/or sensor based on the simulated environmental variables.

9. The home automation system according to claim 1, wherein a detector is configured to detect a user gesture and wherein the processor evaluates the detected user gesture depending on the display of the floor plan and program at least one actuator and/or sensor depending on the user gesture and the currently displayed view of the floor plan.

10. The home automation system according to claim 1, wherein the evaluation device detects the respective receive field strengths and sensor identifications as the current signature for each transmitter from the receive information of at least two sensors.

11. A method for operating a home automation system, comprising the steps of:
displaying a view of at least one part of a floor plan of a spatial environment of the home automation system; and
programming at least one action of an actuator of the home automation system based on the currently displayed view of the floor plan and a function of the actuator and/or a sensor of the home automation system;
wherein from receive signals of a transmitter received by at least two sensors a respective receive field strength together with a transmitter identification and a sensor identification are obtained as receive information and a position from the receive information is determined, such that the mobile display shows a part of the floor plan depending on the detected position within the floor plan.
